(19) United States
(12) Patent Application Publication
(10) Pub. No.: US 2002/0060864 A1
(43) Pub. Date: May 23, 2002

(54) Rear-view mirror for a vehicle, with a reflective surface

(76) Inventors: Rocco Mertsching, Unterkirnach (DE); Jurgen Wolf, Villingen-Schwenningen (DE)

Correspondence Address: Martin A. Farber, Suite 473, 866 United Nations Plaza, New York, NY, 10017, US

(21) Appl. No.: 09/983,007

(22) Filed: Oct. 18, 2001

(30) Foreign Application Priority Data
Oct. 25, 2000 (DE) 100 52 751.5

(51) Int. Cl. G02B 27/14; G02B 5/08; G02B 5/26; G02B 7/182

(52) U.S. Cl. 359/839; 359/883; 359/630

(57) ABSTRACT

In order to develop a rear-view mirror for a vehicle, with a reflective surface, in such a way that the rear-view mirror can firstly provide the driver of the vehicle with depth information based on a physical measurement, and is also capable of displaying further information which is important to the driver, without causing the driver to change viewing direction, it is proposed to equip the reflective surface (1) in a rear-view mirror, at least in a subarea, with a display (3) with a reflective background, the display (3) being capable of displaying text symbols and/or pictograms. In this case, the reflective surface (1), in spite of the inserted information, is intended to remain usable over virtually the entire area for depicting objects located behind the vehicle, and also to require no built-on fittings on the rear-view mirror.

The invention relates to a rear-view mirror for a vehicle, with a reflective surface. Devices of this type are sufficiently well known as a result of multifarious use. For example, many vehicles which are in use are equipped with two side external mirrors and an internal mirror which is arranged in the passenger compartment, in order to make the lateral space and, primarily, the rear space behind the vehicle visible to its driver. One disadvantage of known rear-view mirrors is that these rear-view mirrors can provide only a two-dimensional image of the vehicle environment, specifically in terms of height and width, but not in depth, for physical reasons. The depth information has to be estimated by the driver on the basis of his experience, this empirical procedure naturally tending to a high error rate. A further disadvantage of conventional mirror arrangements is that during the time while the driver is looking into the rear-view mirror, he is generally not able to perceive other optically displayed information, since the displaying devices for this information are located outside the viewing area directed toward the rear-view mirrors.

It is, then, the object of the present invention to develop a rear-view mirror for a vehicle, with a reflective surface, in such a way that the rear-view mirror can firstly provide the driver of the vehicle with depth information based on a physical measurement, and is also capable of displaying further information which is important to the driver, without causing the driver to change viewing direction.

The object is achieved by a rear-view mirror for a vehicle, with a reflective surface, having the features of the first claim. The dependent claims relate to refinements and developments of the solution found.

The solution found is distinguished in particular by the fact that the reflective surface, at least in a subarea, has a display with a reflective background, the display being capable of displaying text symbols and/or pictograms. Furthermore, a distance measuring system is preferably provided which, at least in the rear space of the vehicle, registers the distance between the vehicle and an object located in the environment of the vehicle quantitatively, the distance measuring system displaying the measured distance in the display integrated into the reflective surface.

The invention is now to be explained in more detail using six figures, in which:

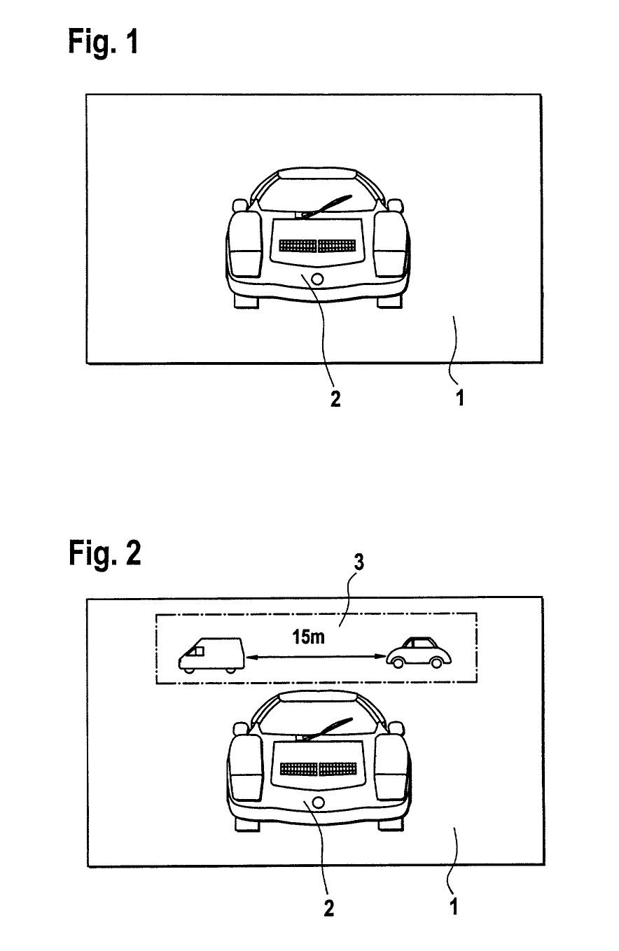

FIG. 1 shows a reflective surface of a conventional rear-view mirror,

FIG. 2 shows a reflective surface of a rear-view mirror with an integrated display,

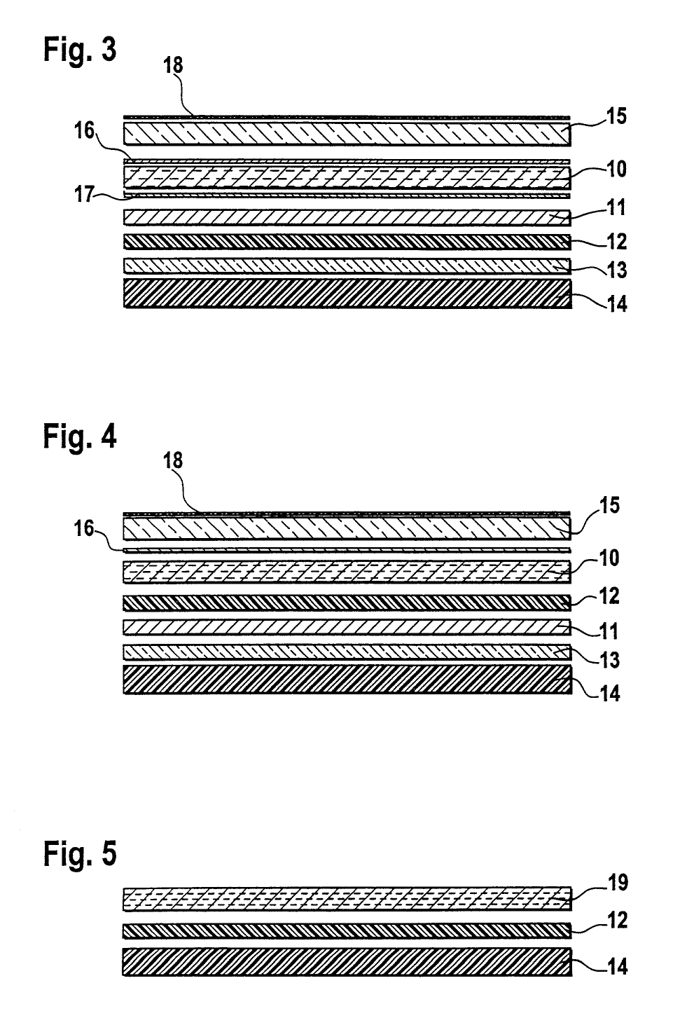

FIG. 3 shows the basic construction of the reflective surface with a liquid-crystal display,

FIG. 4 shows the basic construction of the reflective surface with a liquid-crystal display in connection with a film which is transparent on one side and, on the other side, is both reflective and also polarizing,

FIG. 5 shows the basic construction of the reflective surface with a self-luminous, transparent display and

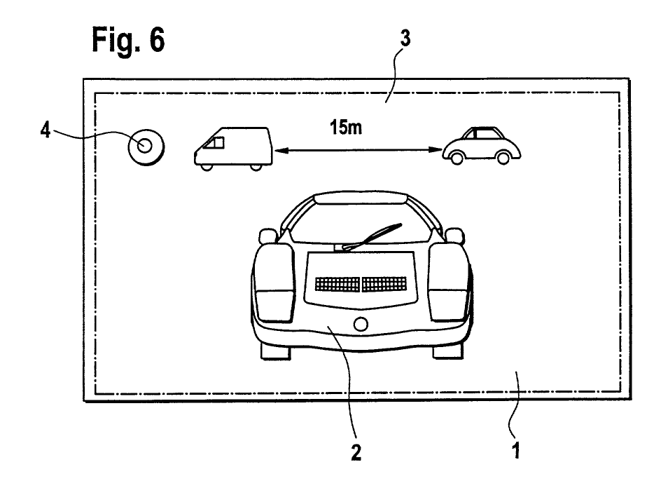

FIG. 6 show a reflective surface with an integrated liquid-crystal display in conjunction with an electronically controlled dipping function.

FIG. 1 shows the reflective surface 1 of a conventional rear-view mirror with an image 2 of an object approaching the vehicle or located in the rear space of the vehicle. The driver, who sees this image 2 in the rear-view mirror of his vehicle, can only estimate the distance between his vehicle and the object. Quantitatively more accurate information about the distance cannot be gathered from the image 2 in the rear-view mirror. In this and the following illustration, the housing and other mechanical components of the rear-view mirror are not shown, since these are adequately known to those skilled in the art.

According to FIG. 2, a display 3 (indicated by the dashed-dotted border) with a reflective background matched to the reflective characteristics and the gloss behavior of the reflective surface 1 is integrated into the reflective surface 1, so that an item of information relating to the distance between the vehicle and the object can be inserted as required into the reflective surface 1 displayed to the driver. This item of information which can be inserted can—as illustrated here—comprise a pictogram and an alphanumeric statement—here, for example, 15 meters. The statement of distance is obtained from a distance measuring system which is connected to the rear-view mirror and which, at least in the rear space of the vehicle, registers the distance between the vehicle and an object external to the vehicle and located in the environment of the vehicle quantitatively, the distance measured by the distance measuring system being displayed on the display 3 in the reflective surface 1 of the rear-view mirror. The distance measuring system can be a distance measuring system operating with radar. The distance information displayed in the display 3 can be adapted continuously to the measured result currently determined by the distance measuring system.

The display 3 is preferably a liquid-crystal display, generally requiring illumination, or a self-luminous, transparent display. Both configurations will now be explained in more detail.

FIG. 3 shows the basic construction of the reflective surface 1 of the proposed rear-view mirror when a liquid-crystal display is used. The reflective surface 1 contains, at least in a subarea, a liquid-crystal display (LCD), which comprises a liquid-crystal cell 10, this liquid-crystal cell 10 comprising, in a known way, a thin and electrically controllable liquid-crystal layer arranged between two glass sheets, these known details of a liquid-crystal cell 10 not being shown in FIG. 3, and the liquid-crystal cell 10 being arranged between an upper polarizer 16 and a lower polarizer 17, the polarizers 16 and 17 being applied directly to the outwardly facing sides of the pack of glass sheets. Placed behind this liquid-crystal display, over the entire area, is a thin reflective film 12, this film 12 being virtually opaque on the side facing the liquid-crystal display and, on this side, possessing excellent reflective characteristics, in order to perform as completely as possible the function of a conventional mirror. On the side facing away from the liquid-crystal display, the film 12 is largely transparent and backed by preferably two-dimensional display backlighting 13. The display backlighting 13 may comprise an electroluminescent film or an organic light-emitting diode formed as a film or plate. If the application or the operating conditions of the rear-view mirror require it, the display backlighting 13 is used for the possibly colored illumination of the liquid-crystal display and, just like the liquid-crystal display, is driven as required by control electronics 14 or else controlled in terms of its brightness. A two-dimensional transparent display heater 11 placed behind the liquid-crystal display is required in order to heat the liquid-crystal display at low ambient temperatures, in order to ensure adequate contrast of the display. Suitable for the display heater 11 are thin indium oxide layers, which are applied to a separate glass sheet or an integrated in the pack of glass sheets of the liquid-crystal display. In addition, the drive circuit for operating the display heater 11 is preferably implemented in conjunction with the control electronics 14. A cover glass 15 protects the construction associated with it against mechanical influences. It is advantageous to render the cover glass 15 nonreflective, at least on the side facing the ambient light, for example by means of the application of a nonreflective coating 18 or structure.

A particularly beneficial structure for the proposed rear-view mirror results if the reflective film 12 can perform the function of the lower polarizer 17 since, in addition to the characteristics already mentioned, it also has a polarizing effect for light. Such a simplified and therefore particularly cost-effective structure is shown by FIG. 4. This structure has the advantage that the light absorption caused by the polarizer 17 is dispensed with, so that the light provided by the display backlighting 13 can be used better. The brightness gain resulting from the omission of the polarizer 17 has been determined, for example, to be 15%. If the original brightness is sufficient, the intensity of light fed into the display backlighting 13 can also be reduced, which leads to cost savings in the light source and its driving.

If, in order to integrate a display 3 into the reflective surface 1 of the rear-view mirror, an active, that is to say a self-luminous, transparent display 19, for example an electroluminescent display, is used instead of the passive liquid-crystal display, that is to say one requiring illumination, the basic structure of the reflective surface 1 is constituted as shown in FIG. 5. In one refinement of the self-luminous, transparent display 19 as an electroluminescent display, which comprises an electroluminescent layer, electrode layers and insulating layers, this display 19 can also have a thin reflective film 12 placed behind it, as described previously in FIG. 3. Instead of the reflective film 12, however, in this case other reflective materials can also be used, since, if a self-luminous, transparent display 19 is used, the single-sided transmitted light capability of the reflective layer is not required for illumination purposes, since this display 19 is itself capable of lighting up. However, backing this display 19, for example with a conventional mirror, leads to a greater, generally undesirable overall depth. As in the refinement shown in FIG. 3, in this case, too, the control electronics 14 needed to drive the display 19 should be accommodated in the housing of the rear-view mirror.

Irrespective of which design is used for the display 3, it is advantageous if the control electronics 14 in each case contains all the electronic components needed to operate the display 3, including a power supply unit that can be connected to the on-board electrical network of the vehicle. The control electronics 14 comprises, in addition to the driver units for the liquid-crystal cell 10 or the self-luminous transparent display 19 and, if appropriate, the drive system for a display heater 11, a programmable data processing unit together with a memory unit associated with the latter, in order to display on the display 3 data going to the data processing unit via a transmission medium, which may be a data bus system arranged in the vehicle, in connection with a data interface. Here, the data to be displayed on the display 3 may originate from a distance measuring system equipped as a self-contained controller or a sensor unit not yet evaluating a measured signal, and can be led to the data processing unit via the transmission medium. Apart from displaying a measured distance to an object located in the environment of the vehicle, other information important to the driver can be inserted in the form of pictograms or text symbols into the reflective surface 1 of the proposed rear-view mirror, via the transmission medium. The memory unit associated with the data processing unit is a nonvolatile memory medium, which is able to contain device-specific parameters such as reference values for the display brightness, but also display-relevant data such as pictograms, character sets and the like. The data processing unit therefore prepares the information to be displayed on the display 3, the driver units accepting the output signals from the data processing unit controlling the actual functions and displays of the display 3.

If a pixel-oriented liquid-crystal display is used for the display 3, then—as displayed in FIG. 6—dipping of the reflective surface 1 can be implemented. In the event of relatively intense incidence of light on the reflective surface 1 of the rear-view mirror, for example as a result of the headlamp light from a following vehicle during night travel, the driver has hitherto been able to escape from a dazzling action brought about by reflections only by means of mechanical adjustment of the rear-view mirror. By contrast, a pixel-oriented liquid-crystal display can be regulated, by means of the data processing unit arranged in the rear-view mirror, in conjunction with at least one light-sensitive sensor 4 arranged in the reflective surface 1, with the effect that the reflective film 12 placed behind the liquid-crystal cell 10 can be darkened as required, depending on the intensity of the incident light, by activating the pixels of the display, as a result of which the reflective surface 1 appears to be more contrasty and therefore free of dazzle to the driver. This dipping function is implemented in that—controlled by the data processing unit—for example a checkered pattern or another suitable pixel pattern is displayed on the display 3 and in this way the reflective action of the reflective film 12 backing the display 3 is weakened. In the event of this function being implemented, the entire reflective surface 1 of the rear-view mirror will preferably be backed by a liquid-crystal display, as displayed by the dash-dotted border in FIG. 6.

One advantage of the proposed rear-view mirror is that, in spite of the inserted information, the reflective surface 1 remains usable over virtually the entire area for depicting objects located behind the vehicle, and, for the display function, no built-on fittings on the rear-view mirror are needed either.

The display 3, in particular as a result of the use of the above-described film 12, which is preferably a film material of only a few hundred micrometers thickness, has a reflective background with a preferably silvery or metallic appearance and has highly reflective characteristics and a contrast-rich gloss, and the capability of reproducing an image sharply in optical terms, so that this display 3 is inserted harmoniously into the known reflective surface 1 of a rear-view mirror, without standing out as a display device, as long as no display is being made. Apart from the preferably silvery or metallic appearance of the reflective background of the display 3, however, other colored displays are also possible as a result of appropriate configuration of the film 12 itself or as a result of the chosen display backlighting 13.

As a result of the flat design, in particular of a display 3 configured as an electroluminescent display, even interior mirrors in a vehicle, which usually have only a low overall depth, can be equipped with the display device according to the invention.

By configuring the rear-view mirror as a data-bus-capable device, depending on the programming of the data processing unit in the control electronics 14, information can be displayed from any desired control devices in the vehicle. For example, it is also possible, in particular in the case of snowfall or dense fog, to display the recordings from an infrared camera fitted to the vehicle in the display 3, or at least to insert suitable pictograms which point out a hazardous situation to the driver if specific violations of limiting values are detected by the data processing unit arranged in the rear-view mirror in conjunction with measured values registered by sensors.

Since display areas positioned optimally for perception are very limited in the vehicle, but the information to be displayed to a driver increases more and more, the proposed integration of a display 3 into a rear-view mirror means a considerable gain in the possible ways in which, at a time at which a driver needs a specific item of information, this can also be presented to him, without diverting his attention from his actual driving task as a result of a change in the viewing direction.

Moreover, in the case of a pixel-oriented liquid-crystal display, it is possible with little expenditure to implement an automatically regulating dipping function as an additional benefit in the case of reflections of interfering external light.

1. Rear-view mirror for a vehicle, with a reflective surface (1), characterized in that the reflective surface (1), at least in a subarea, has a display (3) with a reflective background, the display (3) being capable of displaying text symbols or pictograms.

2. Rear-view mirror according to claim 1, characterized in that a distance measuring system is provided which, at least in the rear space of the vehicle, registers the distance between the vehicle and an object located in the environment of the vehicle quantitatively, the distance measuring system displaying the measured distance in the display (3) integrated into the reflective surface (1).

3. Rear-view mirror according to one of the preceding claims, characterized in that the display (3) is constructed as a liquid-crystal display, the liquid-crystal display being backed by a reflective film (12) which, on the side facing the liquid-crystal display, possesses reflective characteristics and is virtually opaque there, while, from the side facing away from the liquid-crystal display, the film (12) lets light through in order to illuminate the liquid-crystal display.

4. Rear-view mirror according to claim 3, characterized in that the reflective film (12) has a polarizing effect for light.

5. Rear-view mirror according to one of the preceding claims, characterized in that the display (3) is constructed as a transparent, self-luminous display.

6. Rear-view mirror according to one of the preceding claims, characterized in that all the electronic components needed to operate the display (3) are arranged in control electronics (14) in the housing of the rear-view mirror, the control electronics (14) including a programmable data processing unit and a data interface to connect the data processing unit to a data bus system arranged in the vehicle.

7. Rear-view mirror according to one of the preceding claims, characterized in that the display (3) is constructed as a pixel-oriented liquid-crystal display, which can be regulated, by means of the data processing unit arranged in the rear-view mirror, in conjunction with at least one light-sensitive sensor (4) arranged in the reflective surface (1), with the effect that the reflective film (12) placed behind the liquid-crystal display can be darkened by activating the pixels of the liquid-crystal display in the event of interfering reflections of external light.
